(19) United States
(12) Patent Application Publication
(10) Pub. No.: US 2007/0166578 A1
(43) Pub. Date: Jul. 19, 2007

(54) Electric Power Generation System Incorporating A Liquid Feed Fuel Cell

(76) Inventors: Kevin Marchand, Vancouver (CA); Michael Eiche, Richmond (CA); Nimesh Patel, Surrey (CA)

Correspondence Address: MCANDREWS HELD & MALLOY, LTD, 500 WEST MADISON STREET, SUITE 3400, CHICAGO, IL, 60661, US

(21) Appl. No.: 11/617,422

(22) Filed: Dec. 28, 2006

Related U.S. Application Data
(60) Provisional application No. 60/755,169, filed on Dec. 29, 2005.

(51) Int. Cl. H01M 8/24; H01M 8/10

(52) U.S. Cl. 429/18; 429/30

(57) ABSTRACT

An electric power generation system incorporates one or more liquid feed fuel cells, and includes a removable and replaceable fuel cartridge module for storing, delivering and receiving a vaporizable liquid fuel such as aqueous formic acid. The system also includes a fuel delivery module, a fuel cell module, an exhaust module including a vapor cell for consuming unreacted vaporous fuel and a recycle liquid fuel stream, a moisture management module, and a power management module. In operation, a recycle liquid fuel stream is directed back to the fuel delivery module, and vaporous fuel in the fuel cell anode exhaust stream is converted in the vapor cell to substantially benign reaction products. The vapor cell exhaust stream is then directed through a filter in the fuel cartridge module, where residual vaporous fuel is trapped and a benign exhaust stream is discharged from the cartridge module.

### CROSS-REFERENCE TO RELATED APPLICATION(S)

This application relates to and claims priority benefits from U.S. Provisional Patent Application Ser. No. 60/755,169, filed Dec. 29, 2005, entitled “Electric Power Generation System Incorporating A Liquid Feed Fuel Cell”. The '169 provisional application is hereby incorporated by reference herein in its entirety.

### FIELD OF THE INVENTION

The present invention relates generally to direct liquid fuel cell systems. More particularly the invention relates to fuel storage and fuel handling for a liquid fuel cell system with a closed fuel container.

### BACKGROUND OF THE INVENTION

Fuel cells are electrochemical cells in which a free energy change resulting from a fuel oxidation reaction is converted into electrical energy. Organic fuel cells are a useful alternative in many applications to hydrogen fuel cells, overcoming the difficulties of storing and handling hydrogen gas. In an organic fuel cell, an organic fuel such as methanol is oxidized to carbon dioxide at an anode, while air or oxygen is simultaneously reduced to water at a cathode. Organic/air fuel cells have the advantage of operating with a liquid organic fuel. While methanol and other alcohols are typical fuels of choice for direct feed fuel cells, recent advances presented in U.S. Patent Application Publication Nos. 2003/0198852 (“the '852 publication) and 2004/0114418 (“the '418 publication”) disclose formic acid fuel cells with favorably high power densities and output currents. Exemplary power densities of 15 mW/cm² and greater were achieved at low operating temperatures, thereby demonstrating the viability of formic acid fuel cells as compact electric power generation devices.

Fuel cell technology is evolving rapidly as an energy supply for portable electronic devices such as laptop computers and cellular telephones. However, mobile devices and other low power applications require a method to substantially continuously supply fuel to the fuel cells, and as well as a method to replenish the fuel once it becomes depleted. A common method for supplying fuel is to encase the fuel in a closed, pressurized cartridge that is removable and replaceable within the electronic device to be powered. It is therefore desirable for the fuel cell to operate at high power densities and for the stored fuel to have a high latent power density. Accordingly, there is a need to be able to store a relatively high concentration of the fuel to be fed to and consumed by the fuel cell(s). For certain vaporizable organic fuels such as formic acid, storing highly concentrated fuel solutions typically results in problematic fuel vaporization during storage and at typical operating temperature ranges. As a result, low concentrations of the vaporizable fuel are typically employed, thereby limiting stored energy density of the fuel to be fed to the fuel cell(s).

Problems also exist with current methods of operating a fuel cell system in which the fuel to fed to the fuel cells is delivered from a closed pressurized container during fuel cell operation, and in which the flow of fuel should stop positively when not required for fuel cell operation. Operating such system involves the employment of many system components, thereby increasing the size, volume and complexity of such systems and reduced system efficiencies because of a resulting increase in parasitic power drawn from the system by a multiplicity of system components. System simplification to reduce the number, size, volume and complexity of system components, as well as reduction in the amount of parasitic power drawn from the system, can be accomplished by reducing the number and complexity of active components within the system. Making such a system perform effectively, with minimal components, requires careful integration of system components and functions over a range of operating conditions.

In general, unidirectional flow of fuel from a container with a fuel compresses to moderate pressures cannot deliver fuel to the fuel cell system in an effective manner. As the fuel is discharged from the container, a vacuum would eventually be created within the container, and remaining fuel would become undeliverable. Additionally, fuel recycling id desirable in fuel cell systems in which unreacted fuel would be wasted if not returned to its storage container.

The present system design incorporates solutions to the foregoing problems of storing, delivering and recovering liquid fuel to be fed to direct liquid feed fuel cells in a low power range suitable for portable electronic devices such as laptop computers and cellular telephones. Unlike direct methanol fuel cells, the present system is designed to accommodate a vaporizable fuel such as an aqueous formic acid solution by providing for the out-gassing of vaporous fuel.

### SUMMARY OF THE INVENTION

The above and other objectives are achieved by a system for generating electric power from a vaporizable liquid fuel stream. The system includes (a) a fuel cartridge module, (b) a fuel delivery module, (c) a fuel cell module comprising one or more electrochemical fuel cells, and (d) an exhaust module comprising a gas-liquid separator and one or more vapor cells.

The fuel cartridge module comprises:
(1) a cartridge housing having an interior cavity and an exterior surface;
(2) a cartridge liquid fuel stream port encompassed by the housing exterior surface and having a sealable valve accommodating bidirectional flow of the liquid fuel stream into and out of the cartridge module;
(3) a bladder disposed within the interior cavity and capable of storing, delivering and receiving a quantity of the liquid fuel stream;
(4) a compression mechanism for imparting at least a minimal positive fluid pressure to the bladder;
(5) a pressure relief valve for discharging a gaseous stream from the cartridge housing at a set pressure; and
(6) a vacuum relief valve for drawing a gaseous stream into the interior cavity to inhibit formation of a vacuum within the cartridge housing.

The fuel delivery module comprises
(1) a fuel delivery module inlet fluidly connected to the cartridge liquid fuel stream port, the fuel delivery module inlet having a sealable valve accommodating bidirectional flow of the liquid fuel stream into and out of the cartridge module;
(2) a fuel delivery module outlet for discharging a liquid fuel stream suitable for electrocatalytic conversion in a fuel cell to cations and reaction product;
(3) a pump interposed in a fuel delivery conduit for directing the liquid fuel stream between the fuel delivery module inlet and the fuel delivery module outlet;
(4) a recycle liquid fuel stream inlet fluidly connected to the fuel delivery conduit at a junction between the fuel delivery module inlet and the pump.

The fuel cell module, which includes at least one electrochemical fuel cell, comprises:
(1) an anode for promoting electrocatalytic conversion of at least a portion of the fuel delivery module outlet discharged liquid fuel stream to cations and an anode exhaust stream, the anode exhaust stream comprising unreacted fuel stream constituents and anode reaction product;
(2) a cathode for promoting electrocatalytic reaction of the cations with an oxidant stream directed to the cathode, the cathode electrically connected to the anode through a circuit comprising an electrical load, whereby electrons are drawn from the anode to the cathode through the circuit and a cathode exhaust stream is produced;
(3) a cation exchange membrane interposed between the anode and the cathode.

The exhaust module comprises:
(1) an exhaust module inlet for receiving the fuel cell anode exhaust stream;
(2) an exhaust module outlet fluidly connected to the fluid delivery module recycle liquid fuel stream inlet;
(3) a gas-liquid separator interposed between the exhaust module inlet and the exhaust module outlet, the separator comprising:
   (i) a first chamber comprising an inlet for admitting the anode exhaust stream into the first chamber and an outlet for discharging a recycle liquid fuel stream;
   (ii) a second chamber comprising an outlet for discharging a gaseous exhaust stream comprising at least some of the unreacted fuel stream constituents and at least some of the anode reaction product, and
   (iii) a gas-liquid separator membrane interposed between the first chamber and the second chamber, the separator membrane capable of permitting diffusion of at least a portion of the gaseous exhaust stream constituents from the first chamber to the second chamber;
(4) a vapor cell comprising:
   (i) an anode fluidly connected to the gas-liquid separator second chamber outlet, the anode promoting electrocatalytic conversion of at least a portion of the gaseous exhaust stream to cations and a vapor cell anode exhaust stream comprising unreacted gaseous exhaust stream constituents, if any, and vapor cell anode reaction product;
   (ii) a cathode for promoting electrocatalytic reaction of cations produced at the vapor cell anode with an oxidant stream directed to the vapor cell cathode, the vapor cell cathode electrically connected to the vapor cell anode through a circuit comprising an electrical load, whereby electrons are drawn from the vapor cell anode to the vapor cell cathode through the circuit and a vapor cell cathode exhaust stream is produced;
   (iii) a cation exchange membrane interposed between the anode and the cathode.

In operation of the system, the recycle liquid fuel stream is directed to the fuel delivery module outlet through the recycle fuel stream inlet and the fuel delivery conduit, and vaporous fuel in the anode exhaust stream is converted in the vapor cell to cations and reaction product.

In a preferred system embodiment, the cartridge module further comprises a gaseous stream outlet and a gaseous stream filter interposed between the pressure relief valve and the gaseous stream outlet, such that the discharged gaseous stream is passed through the filter to trap contaminants present in the discharged gaseous stream. The cartridge module preferably further comprises an inlet fluidly connected to the fuel cell outlet fuel stream, and the gaseous stream filter is further interposed between the cartridge module inlet and the gaseous stream outlet, such that the fuel cell outlet fuel stream is passed through the filter to trap contaminants present in the fuel cell outlet fuel stream. The gaseous stream filter preferably comprises activated charcoal.

In a preferred system embodiment, the fuel cell module comprises a plurality of electrochemical fuel cells and the fuel delivery module outlet comprises a branched manifold for directing the discharged liquid fuel stream to the fuel cell anodes through a plurality of restricting orifices, such that the discharged liquid fuel stream is distributed substantially evenly among the anodes.

In a preferred system embodiment, the fuel delivery module pump is peristaltic, such that a dosed quantity of the discharged liquid fuel stream is delivered to each of the fuel cell anodes. A check valve is preferably interposed in the recycle liquid fuel stream.

In a preferred system embodiment, the exhaust module vapor cell cathode is preferably electrically connected to the vapor cell anode through one of a shorted circuit and a circuit including a resistive load. The exhaust module preferably further comprises a particulate filter situated between the gas-liquid separator first chamber outlet and the recycle liquid fuel stream inlet. The vaporizable liquid fuel preferably comprises an organic composition, more preferably one in which the vapor cell anode exhaust stream comprises carbon dioxide. The preferred organic composition is formic acid and the vaporous formic acid in the fuel cell anode is converted in the vapor cell to protons, carbon dioxide and water.

In a preferred system embodiment, the system further comprises: (e) a moisture management module comprising:
(1) a water-absorbent wick layer in fluid contact with the at least one fuel cell cathode and with the vapor cell cathode; and
(2) an air plenum in fluid contact with the wick layer for directing an air stream over the wick layer. In operation, at least some water generated at the at least one fuel cell cathode and the vapor cell cathode is drawn away and evaporated into the air stream.

In a preferred system embodiment, the air stream in the moisture management module is preferably directed over the wick layer by an air plenum fan. A pair of water barrier membranes preferably cover opposing ends of the air plenum, each of the water barrier membranes being permeable to gaseous streams and substantially impermeable to liquid water.

In a preferred system embodiment, the system further comprises: (g) a power management module electrically connected to at least one of the fuel cartridge module, the fuel delivery module, the fuel cell module, the exhaust module and the moisture management module. The power management module preferably comprises an electrical energy storage device interposed between the fuel cell module and the load for receiving, storing and delivering electrical energy generated by the fuel cell module to the load. The power management module preferably further comprises a microcontroller capable of regulating charging of the storage device by the fuel cell module. The preferred electrical energy storage device comprises a storage battery and/or a capacitor. The power management module preferably further comprises a fan control device for regulating flow of the plenum air stream. A cell voltage monitor is preferably electrically connected to the microcontroller, and is capable of directing electrical signals to the microcontroller in response to voltage variations across the at least one fuel cell. The microcontroller effectuates a responsive operational change in at least one of the fuel delivery module, the fuel cell module, the exhaust module and the moisture management module.

In another preferred system embodiment, the fuel delivery module comprises:
(1) a fuel delivery module inlet fluidly connected to the cartridge liquid fuel stream port, the fuel delivery module inlet having a sealable valve accommodating bidirectional flow of the liquid fuel stream into and out of the cartridge module;
(2) a fuel delivery module outlet for discharging a liquid fuel stream suitable for electrocatalytic conversion in a fuel cell to cations and reaction product;
(3) a passive device interposed in a fuel delivery conduit between first and second valves for directing the liquid fuel stream between the fuel delivery module inlet and the fuel delivery module outlet, the passive device comprising an expandable bladder and a compression mechanism for imparting at least minimal positive pressure to the passive device bladder, such that:
   (i) when the first valve is in the open position and the second valve is in the closed position, the passive device bladder receives a quantity of liquid fuel from the liquid fuel stream;
   (ii) when the first and second valves are each in the closed position, the quantity of liquid fuel is stored in the passive device bladder in pressurized form; and
   (iii) when the first valve is in the closed position and the second valve is in the open position, a dosed quantity of liquid fuel is delivered to the fuel delivery module outlet; and
(4) a recycle liquid fuel stream inlet fluidly connected to the fuel delivery conduit at a junction between the fuel delivery module inlet and the passive device.

### BRIEF DESCRIPTION OF THE DRAWING(S)

FIG. 1, which is a composite of FIGS. 1A and 1B, as indicated, is a schematic flow diagram an embodiment of the present electric power generation system incorporating one or more liquid feed fuel cells, in which a peristaltic pump is employed to deliver a dosed quantity of liquid fuel to the fuel cell anode(s).

FIG. 2, which is a composite of FIGS. 2A and 2B, as indicated, is a schematic flow diagram of another embodiment of the present electric power generation system incorporating one or more liquid feed fuel cells, in which a compressed bladder interposed between a pair of valves is employed to deliver a dosed quantity of liquid fuel to the fuel cell anode(s).

### DETAILED DESCRIPTION OF PREFERRED EMBODIMENT(S)

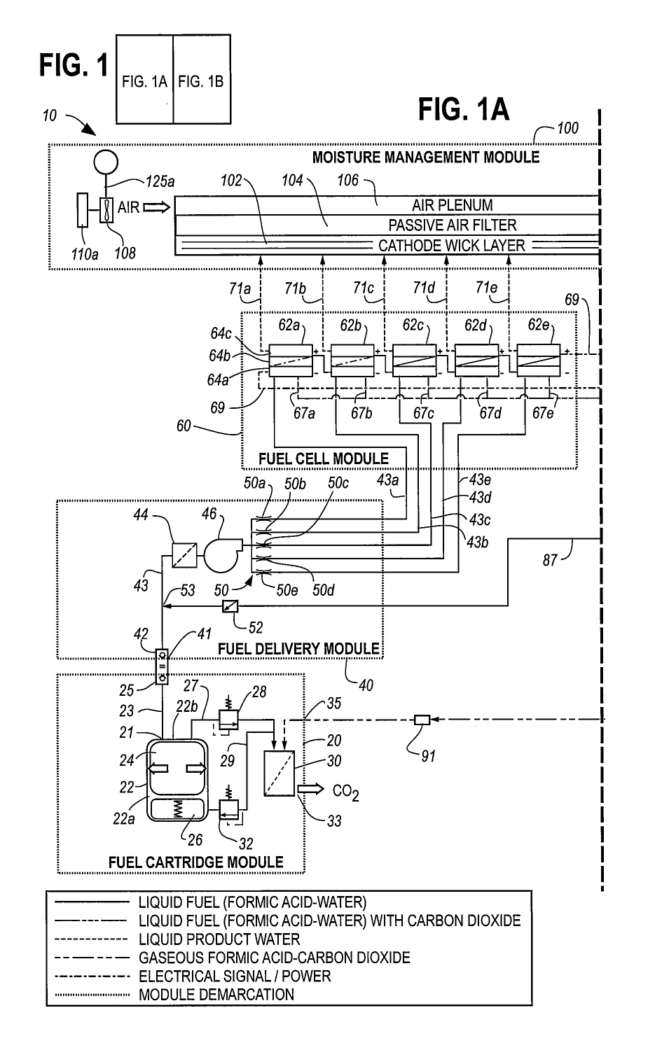

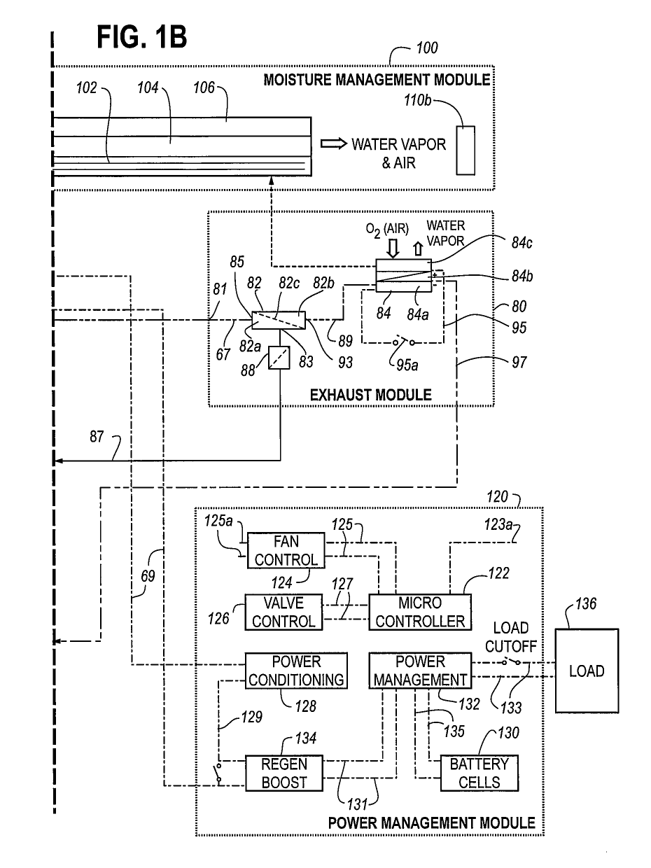

Turning to FIG. 1, an embodiment of the present electric power generation system 10, which incorporates one or more liquid feed fuel cells, is depicted schematically. System 10 includes a removable and replaceable fuel cartridge module 20 for storing, delivering and receiving a vaporizable liquid fuel such as, for example, liquid formic acid. A fuel delivery module 40 draws liquid fuel from fuel cartridge module 20 and directs a liquid fuel stream to a fuel cell module 60, in which one or more fuel cells generate electric power. An exhaust module 80 processes the anode exhaust stream fuel cell, including unreacted liquid fuel, as well as vaporous fuel and anode reaction byproducts, and directs a recycle liquid fuel stream back to fuel delivery module 40 after removing vaporous fuel in a vapor cell. A moisture management module 100 draws accumulated cathode product water away from fuel cell module 40 and from the vapor cell incorporated in exhaust module 80. A power management module 120 manages the operation of system 10, and in particular regulates the charging of battery cells interposed between fuel cell module 40 and the electrical load to be driven by system 10. Power management module 120 also effectuates operational changes in fuel delivery module 40, fuel cell module 60, exhaust module 80 and/or moisture management module 100 in response to changes in fuel cell performance.

Fuel Cartridge Module

As shown in FIG. 1, fuel cartridge module 20 includes a cartridge housing 22 having an interior cavity 22a and an exterior surface 22b. A cartridge liquid fuel stream port 21 is encompassed by housing exterior surface 22b and has a sealable valve 25, which accommodates bidirectional flow of liquid fuel stream 23 into and out of cartridge module 20. A bladder 24 disposed within housing interior cavity 22a is capable of storing, delivering and receiving a liquid fuel stream 23. A compression mechanism 26, shown as being spring-actuated imparts at least a minimal positive fluid pressure to bladder 24. A pressure relief valve 28 discharges a gaseous stream 27 from cartridge housing 22 at a set pressure. A vacuum relief valve 32 draws a gaseous stream 29 into housing interior cavity 22a to inhibit formation of a vacuum within cartridge housing 22.

As further illustrated in FIG. 1, cartridge module 20 further includes a gaseous stream outlet 33 and a gaseous stream filter 30 interposed between pressure relief valve 28 and gaseous stream outlet 33. Discharged gaseous stream 27 is passed through filter 30 to trap contaminants present in discharged gaseous stream 27. Cartridge module 20 also includes an inlet 35 fluidly connected to a fuel cell outlet fuel stream 89, and as shown in FIG. 1, gaseous stream filter 30 is also interposed between cartridge module inlet 35 and gaseous stream outlet 33. As explained in more detail below in connection with fuel cell module 60 and exhaust module 80, fuel cell outlet fuel stream 89 is passed through filter 30 to trap contaminants present in fuel cell outlet fuel stream 89. Gaseous stream filter 30 preferably comprises activated charcoal, but can also include or be made up of materials suitable for trapping vaporous formic acid and other organic fuel stream contaminants like carbon monoxide.

Fuel Delivery Module

As shown in FIG. 1, fuel delivery module 40 includes a fuel delivery module inlet 41 fluidly connected to cartridge liquid fuel stream port 21. Inlet 41 has a sealable valve 42 that mates with sealable valve 25 of cartridge module 20, and like cartridge valve 25 accommodates bidirectional flow of liquid fuel stream into and out of cartridge module 20. Fuel delivery module outlet 50, shown in FIG. 1 as a branched manifold, discharges a liquid fuel stream suitable for electrocatalytic conversion in fuel cell module 60 to cations and reaction product. A pump 46 is interposed in fuel delivery conduit 43 for directing liquid fuel stream 23 between fuel delivery module inlet 41 and fuel delivery module outlet 50. A recycle liquid fuel stream inlet 53 is fluidly connected to fuel delivery conduit 43 at a junction between fuel delivery module inlet 41 and pump 46. A particulate filter is interposed in fuel delivery conduit 43 between junction 53 and pump 46.

In the case where fuel cell module 60 includes two or more electrochemical fuel cells, as shown in FIG. 1, in which fuel cell module 60 employs five fuel cells 62a, 62b, 62c, 62d and 62e, fuel delivery module outlet 50 preferably takes the form of a branched manifold for directing discharged liquid fuel stream 23 to the fuel cell anodes, one of which is shown in FIG. 1 as anode 64a, through a plurality of restricting orifices 50a, 50b, 50c, 50d and 50e. Discharged liquid fuel stream 23 is thereby distributed substantially evenly among the anodes of fuel cells 62a, 62b, 62c, 62d and 62e.

Pump 46 in system 10 is preferably peristaltic, such that a dosed quantity of discharged liquid fuel stream 23 is delivered to each of the anodes of fuel cells 62a, 62b, 62c, 62d and 62e.

As shown in FIG. 1, a check valve 91 is interposed between exhaust stream outlet 83 and junction 53, thereby restricting flow of recycle liquid fuel stream in the direction from exhaust stream outlet 83 to junction 53.

Fuel Cell Module

Fuel cell module 60 includes one or more electrochemical fuel cells, shown in FIG. 1 as five fuel cells 62a, 62b, 62c, 62d and 62e. Each fuel cell includes an anode, one of which is shown in FIG. 1 as anode 64a, for promoting electrocatalytic conversion of at least a portion of liquid fuel stream 43a discharged from branched manifold outlet 50 of fuel delivery module 40 to cations and an anode exhaust stream 67a. Similarly, the anodes of each of fuel cells 62b, 62c, 62d and 62e promote electrocatalytic conversion of at least a portion of liquid fuel streams 43b, 43c, 43d and 43e, respectively, discharged from branched manifold outlet 50 of fuel delivery module 40 to cations and anode exhaust streams 67b, 67c, 67d and 67e, respectively. Anode exhaust streams 67a, 67b, 67c, 67d and 67e comprise unreacted fuel stream constituents and anode reaction product. In the case of an aqueous formic acid fuel stream, the anode reaction product would include water, carbon dioxide and a trace amount of carbon monoxide.

Each of fuel cells 62a, 62b, 62c, 62d and 62e also includes a cathode, one of which is shown in FIG. 1 as cathode 64c, for promoting electrocatalytic reaction of cations formed at the fuel cell anodes with an oxidant stream directed to the cathodes. The cathodes of fuel cells 62a, 62b, 62c, 62d and 62e are electrically connected to the anodes of fuel cells 62a, 62b, 62c, 62d and 62e through a circuit 69 having an electrical load (shown as load 136 of power management module 120, and explained in more detail below) interposed in circuit 69. Electrons generated at the anodes of fuel cells 62a, 62b, 62c, 62d and 62e are drawn to the cathodes through circuit 69 to drive load 136 and cathode exhaust streams are produced. Cathode exhaust stream exhaust streams 71a, 71b, 71c, 71d and 71e are discharged from the cathodes of fuel cells 62a, 62b, 62c, 62d and 62e, respectively.

In each of fuel cells 62a, 62b, 62c, 62d and 62e, a cation exchange membrane, one of which is shown in FIG. 1 as cation exchange membrane 64b, is interposed between each anode (one of which is shown in FIG. 1 as anode 64a) and each cathode (one of which is shown in FIG. 1 as cathode 64c). Cation exchange membrane facilitates the migration of cations (also referred to as protons or hydrogen ions) from anode electrocatalytic reaction sites to cathode electrocatalytic reaction sites.

Exhaust Module

Exhaust module 80 includes an exhaust module inlet 81 for receiving consolidated fuel cell anode exhaust stream 67 and an exhaust module outlet 83 fluidly connected to fluid delivery module recycle liquid fuel stream inlet 53. A gas-liquid separator 82 is interposed between exhaust module inlet 81 and exhaust module outlet 83. One or more vapor cells, which in system 10 of FIG. 1 consists of a single vapor cell 84, consumes and electrocatalytically converts a vaporous fuel stream discharged from a chamber of gas-liquid separator 82 to benign reaction product, as explained in more detail below.

Gas-liquid separator 82 includes a first chamber 82a and a second chamber 82b. First chamber 82a includes an inlet 85 for admitting anode exhaust stream 67 into first chamber 82a and an outlet 83 for discharging a recycle liquid fuel stream 87. Exhaust module 80 preferably includes a particulate filter 88 interposed in recycle liquid fuel stream 87 discharged from gas-liquid separator first chamber outlet 83. Second chamber 82b includes an outlet 93 for discharging a gaseous exhaust stream 89.

A gas-liquid separator membrane 82c is interposed between first chamber 82a and second chamber 82b of gas-liquid separator 82. Separator membrane 82c permits diffusion of at least a portion of the gaseous exhaust stream constituents present in anode exhaust stream 67, from first chamber 82a to second chamber 82b. Gaseous exhaust stream 89 is discharged from second chamber 82b.

Vapor cell 84 has a configuration that is substantially identical to fuel cells 62a, 62b, 62c, 62d and 62e, and includes an anode 84a, which is fluidly connected to gas-liquid separator second chamber outlet 93. Vapor cell anode 84a promotes electrocatalytic conversion of at least a portion of gaseous exhaust stream 89 to cations and a vapor cell anode exhaust stream 97. Vapor cell anode exhaust stream 97 includes unreacted constituents from gaseous exhaust stream 89, if any, and vapor cell anode reaction product.

Vapor cell 84 also includes a cathode 84c for promoting electrocatalytic reaction of cations produced at vapor cell anode 84a with an oxidant stream (depicted as oxygen (O₂) from air in FIG. 1) directed to vapor cell cathode 84c. A cation exchange membrane 84b is interposed between vapor cell anode 84a and vapor cell cathode 84c. Vapor cell cathode 84c is electrically connected to vapor cell anode 84a through a circuit 95 that includes an electrical load (shown in FIG. 1 as a switch 95a for shorting circuit 95). Electrons are thereby drawn from vapor cell anode 84a to vapor cell cathode 84c through circuit 95 and a vapor cell cathode exhaust stream 97 is produced.

Moisture Management Module

As shown in FIG. 1, moisture management module 100 includes a water-absorbing wick layer 102 in fluid contact with the cathodes of fuel cells 62a, 62b, 62c, 62d and 62e, one cathode of which is illustrated in FIG. 1 as cathode 64c. As further shown in FIG. 1, cathode exhaust streams 71a, 71b, 71c, 71d and 71e pass through wick layer 102, such that water entrained in the cathode exhaust streams can be absorbed. Wick layer is also preferably in fluid contact with vapor cell cathode 84c and the exhaust stream discharged from vapor cell cathode 84c (labeled “Water Vapor” in FIG. 1.

An air plenum 106 in fluid contact with wick layer 102 directs an air stream over wick layer 102 such that at least some of the water generated at fuel cell cathode 64c and the other fuel cell cathodes, as well as at least some of the water generated at vapor cell cathode 84c is drawn away and evaporated into the air stream directed through plenum 106. A passive air filter 104 is preferably interposed between wick layer 102 and air plenum 106. As further shown in FIG. 1, an air stream is directed over wick layer 102 by an air plenum fan 108, the flow of which is controlled by a signal 125a generated by a microcontroller in power management module 120, as described in mode detail below. A pair of water barrier membranes 110a, 110b cover opposing ends of air plenum 106, as shown in FIG. 1. Water barrier membranes 110a, 110b are permeable to gaseous streams and substantially impermeable to liquid water.

Power Management Module

As further shown in FIG. 1, a power management module 120 is electrically connected to one or more of fuel cartridge module 20, fuel delivery module 40, fuel cell module 60, exhaust module 80 and moisture management module 100. Power management module 120 includes an electrical energy storage device 130, shown in FIG. 1 as a storage battery, interposed between fuel cell module 40 and electrical load 136. Storage device 130 receives, stores and delivers electrical energy generated by fuel cell module 40 to load 136. Power management module 120 also includes a microcontroller 122 capable of regulating charging of storage device 130 by fuel cell module 40. Storage device 130 could alternatively and/or additionally include capacitor or other like electrical device for receiving, storing and delivering electrical energy.

As further shown in FIG. 1, power management module 120 can also include a fan control device 124, in turn electrically connected to and responsive to microcontroller 122, for regulating, via signal 125a, flow of the air stream directed by fan 108 through plenum 106 in moisture management module 100.

Power management module 100 can also include a cell voltage monitor electrically connected to and/or integral with microcontroller 122. The cell voltage monitor is capable of directing electrical signals to microcontroller 122 in response to voltage variations across fuel cells 62a, 62b, 62c, 62d and 62e. Microcontroller 122 is also capable of effectuating operational changes via electrical signals, one of which is depicted in FIG. 1 as signal 123a, directed to one or more of fuel delivery module 40, fuel cell module 60, exhaust module 80 and moisture management module 100 in response to such voltage variations.

As illustrated in FIG. 1, power management module 120 includes a valve control device 126 responsive to microcontroller 122 via signal circuit 127. A power-conditioning device 128 is in series with regenerative boost device 134 via circuit 69 interconnecting the fuel cell anodes and fuel cell cathodes. Regenerative boost device 131 is in turn responsive to power management device 132 via signal circuit 131. Power management device 134 in turn regulates the charging of electrical energy storage device 130 (battery cells in FIG. 1) by fuel cell module 60, and also directs electric power to electrical load 136 via circuit 133.

System Operation

In operation of system 10 as described, recycle liquid fuel stream 87 is directed via fuel delivery module recycle fuel stream inlet 53 and pump 46 to fuel delivery module outlet 50, and vaporous fuel in anode exhaust stream 67 is converted in vapor cell 84 to substantially benign vapor cell anode reaction product and unreacted gaseous exhaust stream constituents, if any. Such unreacted gaseous exhaust stream constituents are then directed through cartridge filter 30, where they are trapped and a benign exhaust stream is discharged from cartridge module 20.

System 10 is especially well-suited to vaporizable liquid fuels capable of electrocatalytic conversion in direct liquid feed fuel cells. Preferred fuels include vaporizable liquid organic compositions capable of electrocatalytic conversion in direct liquid feed fuel cells, especially those in which vapor cell anode exhaust stream 97 contains carbon dioxide. System 10 is particularly well-suited to formic acid, more particularly an aqueous formic acid solution, which is a vaporizable liquid organic composition capable of electrocatalytic conversion to protons, carbon dioxide and water in anodes of direct liquid feed fuel cells. The present system enables recycling of unreacted formic acid in liquid form, while vaporous fuel present in the anode exhaust stream is separated from liquid formic acid in a gas-liquid separator, and the vaporous fuel is then consumed and converted in a vapor cell to form a substantially benign reaction product of carbon dioxide and water.

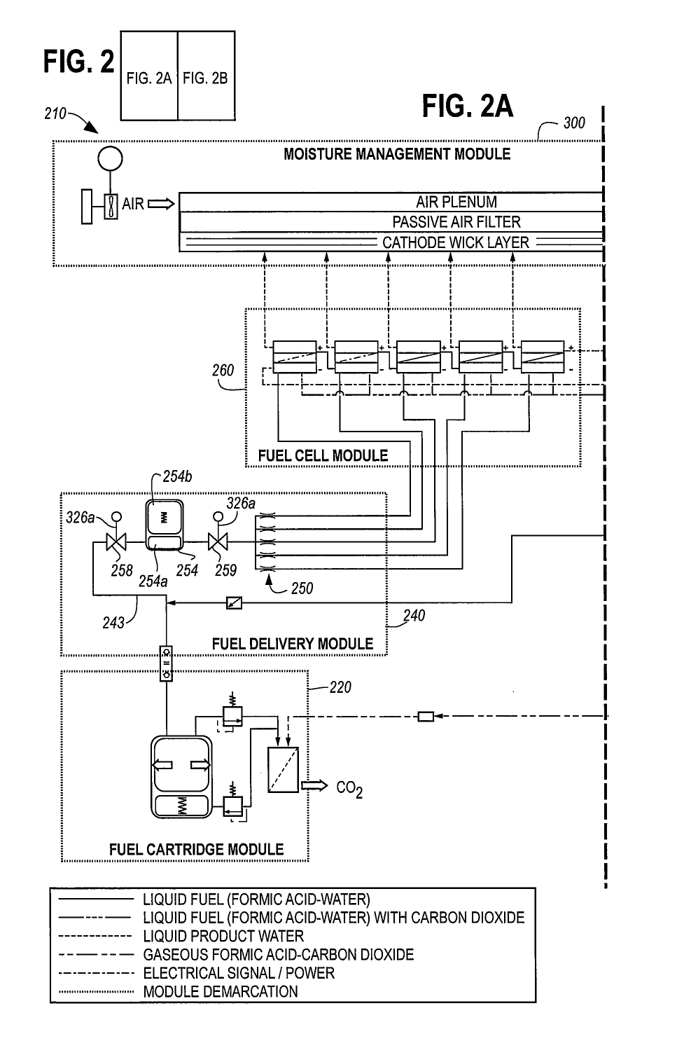

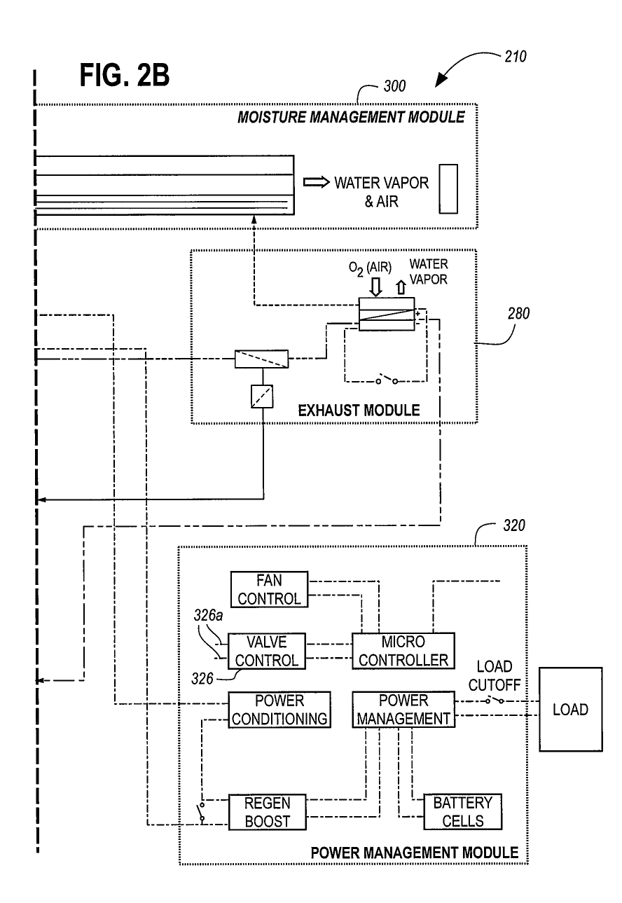

FIG. 2 schematically illustrates another embodiment of the present electric power generation system. As with system 10 of FIG. 1, system 210 of FIG. 2, includes a fuel cartridge module 220, a fuel delivery module 240, a fuel cell module 260, an exhaust module 280, a moisture management module 300 and a power management module 320. In place of pump 46 and filter 44 in FIG. 1, however, system 210 of FIG. 2 employs a passive bladder-type device 254 interposed between a pair of valves 258, 259 to deliver a dosed quantity of liquid fuel to the fuel cell anode(s). Device 254 includes an expandable bladder 254a and a compression mechanism 254b for imparting at least minimal positive pressure to bladder 254a. When valve 258 is in the open position and valve 259 is in the closed position, bladder 254a receives a quantity of liquid fuel from stream 243, where it is stored in pressurized form when valves 258, 259 are each in the closed position. When valve 258 is in the closed position and valve 259 is in the open position, a dosed quantity of liquid fuel is delivered to fuel delivery module outlet 250 (shown in FIG. 2 as a branched manifold), where it is then directed to the anodes of fuel cell module 260. A valve control device 326 in power management module 320 directs signals via control circuit 326a to valves 258, 259, thereby opening and closing valves 258, 259 depending upon whether bladder 254a is to (a) receive a quantity of liquid fuel via stream 243, (b) store a quantity of fuel, or (c) supply a dosed quantity of fuel to fuel delivery module outlet 250.

While particular steps, elements, embodiments and applications of the present invention have been shown and described, it will be understood, of course, that the invention is not limited thereto since modifications can be made by those skilled in the art, particularly in light of the foregoing teachings.

What is claimed is:

1. A system for generating electric power from a vaporizable liquid fuel stream, the system comprising:
(a) a fuel cartridge module comprising:
(1) a cartridge housing having an interior cavity and an exterior surface;
(2) a cartridge liquid fuel stream port encompassed by said housing exterior surface and having a sealable valve accommodating bidirectional flow of said liquid fuel stream into and out of said cartridge module;
(3) a bladder disposed within said interior cavity and capable of storing, delivering and receiving a quantity of said liquid fuel stream;
(4) a compression mechanism for imparting at least a minimal positive fluid pressure to said bladder;
(5) a pressure relief valve for discharging a gaseous stream from said cartridge housing at a set pressure; and
(6) a vacuum relief valve for drawing a gaseous stream into said interior cavity to inhibit formation of a vacuum within said cartridge housing;
(b) a fuel delivery module comprising:
(1) a fuel delivery module inlet fluidly connected to said cartridge liquid fuel stream port, said fuel delivery module inlet having a sealable valve accommodating bidirectional flow of said liquid fuel stream into and out of said cartridge module;
(2) a fuel delivery module outlet for discharging a liquid fuel stream suitable for electrocatalytic conversion in a fuel cell to cations and reaction product;
(3) a pump interposed in a fuel delivery conduit for directing said liquid fuel stream between said fuel delivery module inlet and said fuel delivery module outlet;
(4) a recycle liquid fuel stream inlet fluidly connected to said fuel delivery conduit at a junction between said fuel delivery module inlet and said pump;
(c) a fuel cell module comprising at least one electrochemical fuel cell comprising:
(1) an anode for promoting electrocatalytic conversion of at least a portion of said fuel delivery module outlet discharged liquid fuel stream to cations and an anode exhaust stream, said anode exhaust stream comprising unreacted fuel stream constituents and anode reaction product;
(2) a cathode for promoting electrocatalytic reaction of said cations with an oxidant stream directed to said cathode, said cathode electrically connected to said anode through a circuit comprising an electrical load, whereby electrons are drawn from said anode to said cathode through said circuit and a cathode exhaust stream is produced;
(3) a cation exchange membrane interposed between said anode and said cathode;
(d) an exhaust module comprising:
(1) an exhaust module inlet for receiving said fuel cell anode exhaust stream;
(2) an exhaust module outlet fluidly connected to said fluid delivery module recycle liquid fuel stream inlet;
(3) a gas-liquid separator interposed between said exhaust module inlet and said exhaust module outlet, said separator comprising:
(i) a first chamber comprising an inlet for admitting said anode exhaust stream into said first chamber and an outlet for discharging a recycle liquid fuel stream;
(ii) a second chamber comprising an outlet for discharging a gaseous exhaust stream comprising at least some of said unreacted fuel stream constituents and at least some of said anode reaction product, and
(iii) a gas-liquid separator membrane interposed between said first chamber and said second chamber, said separator membrane capable of permitting diffusion of at least a portion of said gaseous exhaust stream constituents from said first chamber to said second chamber;
(4) a vapor cell comprising:
(i) an anode fluidly connected to said gas-liquid separator second chamber outlet, said anode promoting electrocatalytic conversion of at least a portion of said gaseous exhaust stream to cations and a vapor cell anode exhaust stream comprising unreacted gaseous exhaust stream constituents, if any, and vapor cell anode reaction product;
(ii) a cathode for promoting electrocatalytic reaction of cations produced at said vapor cell anode with an oxidant stream directed to said vapor cell cathode, said vapor cell cathode electrically connected to said vapor cell anode through a circuit comprising an electrical load, whereby electrons are drawn from said vapor cell anode to said vapor cell cathode through said circuit and a vapor cell cathode exhaust stream is produced;
(iii) a cation exchange membrane interposed between said anode and said cathode;
whereby said recycle liquid fuel stream is directed to said fuel delivery module outlet through said recycle fuel stream inlet and said fuel delivery conduit, and vaporous fuel in said anode exhaust stream is converted in said vapor cell to cations and reaction product.

2. The system of claim 1, wherein said cartridge module further comprises a gaseous stream outlet and a gaseous stream filter interposed between said pressure relief valve and said gaseous stream outlet, whereby said discharged gaseous stream is passed through said filter to trap contaminants present in said discharged gaseous stream.

3. The system of claim 2, wherein said cartridge module further comprises an inlet fluidly connected to said fuel cell outlet fuel stream, and said gaseous stream filter is further interposed between said cartridge module inlet and said gaseous stream outlet, whereby said fuel cell outlet fuel stream is passed through said filter to trap contaminants present in said fuel cell outlet fuel stream.

4. The system of claim 3, wherein said gaseous stream filter comprises activated charcoal.

5. The system of claim 1, wherein said fuel cell module comprises a plurality of electrochemical fuel cells and said fuel delivery module outlet comprises a branched manifold for directing said discharged liquid fuel stream to said fuel cell anodes through a plurality of restricting orifices, whereby said discharged liquid fuel stream is distributed substantially evenly among said anodes.

6. The system of claim 1, wherein said pump is peristaltic, whereby a dosed quantity of said discharged liquid fuel stream is delivered to said at least one fuel cell anode.

7. The system of claim 5, wherein said pump is peristaltic, whereby a dosed quantity of said discharged liquid fuel stream is delivered to each of said fuel cell anodes.

8. The system of claim 1, wherein a check valve is interposed in said recycle liquid fuel stream.

9. The system of claim 1, wherein said vapor cell cathode is electrically connected to said vapor cell anode through one of a shorted circuit and a circuit including a resistive load.

10. The system of claim 1, wherein said exhaust module further comprises a particulate filter situated between said gas-liquid separator first chamber outlet and said recycle liquid fuel stream inlet.

11. The system of claim 1, wherein said vaporizable liquid fuel comprises an organic composition.

12. The system of claim 11, wherein said vapor cell anode exhaust stream comprises carbon dioxide.

13. The system of claim 12, wherein said organic composition is formic acid and wherein vaporous formic acid in said fuel cell anode is converted in said vapor cell to protons, carbon dioxide and water.

14. The system of claim 1, wherein said system further comprises:
(e) a moisture management module comprising:
(1) a water-absorbent wick layer in fluid contact with said at least one fuel cell cathode and with said vapor cell cathode; and
(2) an air plenum in fluid contact with said wick layer for directing an air stream over said wick layer;
whereby at least some water generated at said at least one fuel cell cathode and said vapor cell cathode is drawn away and evaporated into said air stream.

15. The system of claim 14, wherein said air stream is directed over said wick layer by an air plenum fan.

16. The system of claim 1, wherein a pair of water barrier membranes cover opposing ends of said air plenum, each of said water barrier membranes permeable to gaseous streams and substantially impermeable to liquid water.

17. The system of claim 1, further comprising:
(f) a power management module electrically connected to at least one of said fuel cartridge module, said fuel delivery module, said fuel cell module, said exhaust module and said moisture management module, said power management module comprising an electrical energy storage device interposed between said fuel cell module and said load for receiving, storing and delivering electrical energy generated by said fuel cell module to said load, said power management module further comprising a microcontroller capable of regulating charging of said storage device by said fuel cell module.

18. The system of claim 17, wherein said electrical energy storage device comprises a storage battery.

19. The system of claim 17, wherein said electrical energy storage device comprises a capacitor.

20. The system of claim 17, wherein said power management module further comprises a fan control device for regulating flow of said plenum air stream.

21. The system of claim 17, wherein said power management module further comprises a cell voltage monitor electrically connected to said microcontroller, said cell voltage monitor capable of directing electrical signals to said microcontroller in response to voltage variations across said at least one fuel cell, said microcontroller effectuating a responsive operational change in at least one of said fuel delivery module, said fuel cell module, said exhaust module and said moisture management module.

22. The system of claim 1, wherein said fuel delivery module comprises:
(1) a fuel delivery module inlet fluidly connected to said cartridge liquid fuel stream port, said fuel delivery module inlet having a sealable valve accommodating bidirectional flow of said liquid fuel stream into and out of said cartridge module;
(2) a fuel delivery module outlet for discharging a liquid fuel stream suitable for electrocatalytic conversion in a fuel cell to cations and reaction product;
(3) a passive device interposed in a fuel delivery conduit between first and second valves for directing said liquid fuel stream between said fuel delivery module inlet and said fuel delivery module outlet, said passive device comprising an expandable bladder and a compression mechanism for imparting at least minimal positive pressure to said passive device bladder, whereby:
(i) when said first valve is in the open position and said second valve is in the closed position, said passive device bladder receives a quantity of liquid fuel from said liquid fuel stream;
(ii) when said first and second valves are each in the closed position, said quantity of liquid fuel is stored in said passive device bladder in pressurized form; and
(iii) when said first valve is in the closed position and said second valve is in the open position, a dosed quantity of liquid fuel is delivered to said fuel delivery module outlet;
(4) a recycle liquid fuel stream inlet fluidly connected to said fuel delivery conduit at a junction between said fuel delivery module inlet and said passive device.
